(19) United States
(12) Patent Application Publication
(10) Pub. No.: US 2005/0101307 A1
(43) Pub. Date: May 12, 2005

(54) Method for performing a voting by mobile terminals

(75) Inventors: Torsten Brugge, Waiblingen (DE); Wolfgang Lautenschlager, Weissach-Flacht (DE); Harald Orlamunder, Ditzingen (DE)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 10/963,819

(22) Filed: Oct. 14, 2004

(30) Foreign Application Priority Data
Nov. 10, 2003 (EP) 03 292 805.3

(51) Int. Cl. H04M 11/00

(52) U.S. Cl. 455/414.1; 455/412.1

(57) ABSTRACT

The invention concerns a method for performing a voting, as well as a vote server, a mobile terminal and a computer program product used for the implementation of this method. The vote server generates a unique transaction number associated with a specific voting item and a specific subscriber. It transmits the unique transaction number together with the specific voting item to the mobile terminal of the specific subscriber. The mobile terminal sends back a response comprising the vote together with the transaction number and a unique identification number associated with the subscriber of the mobile terminal. The vote server compares the received transaction number and the received identification number with stored values and accepts the vote contained in the response, if the check is positive.

### TECHNICAL FIELD

The present invention relates to a method for performing a voting, wherein a mobile terminal receives a voting item from a vote server and sends back a response comprising the vote of the subscriber of said mobile terminal. The present invention further relates to a vote server comprising a communication unit for communicating with mobile terminals through a communication network, a mobile terminal comprising a communication unit for communicating with a vote server through a communication network and a computer program product. The invention is based on a priority application EP 03292805.3 which is hereby incorporated by reference.

### BACKGROUND OF THE INVENTION

DE 101 56 414 A1 describes a voting procedure, wherein votes are collected by help of mobile terminals. A vote server comprises a data base storing several voting items. A predefined voting period is assigned to each of these voting items. Voting items are transmitted from the vote server to mobile terminals. Then, mobile terminals direct votes to the vote server. If the vote server receives such a vote within the time limit set within the data base, it stores the vote.

It is the object of the present invention to provide an improved voting by mobile terminals.

### SUMMARY OF THE INVENTION

The object of the present invention is achieved by a method for performing a voting, wherein a mobile terminal receives a voting item from a vote server and sends back a response comprising the vote of the subscriber of that mobile terminal, the method comprising the steps of: generating a unique transaction number associated with a specific voting item and a specific subscriber, transmitting the unique transaction number together with a specific voting item from the vote server to the mobile terminal of the specific subscriber, sending a response comprising the vote together with the transaction number and a unique identification number associated with the subscriber of the mobile terminal to the vote server; and comparing, by the vote server, the received transaction number and the received identification number with stored values and accepting the vote contained in the response, if the check is positive. The object of the present invention is further achieved by a vote server for supporting a voting, the vote server comprises a communication unit for communicating with mobile terminals through a communication network and a control unit, wherein the control unit generates unique transaction numbers, each transaction number is associated with a specific voting item and a specific subscriber, transmits a corresponding unique transaction number together with a voting item to a mobile terminal of a subscriber, who is invited to a vote, receives a corresponding response from the mobile terminal, wherein the response comprises the vote together with the transaction number and a unique identification number associated with the subscriber of the mobile terminal, and compares the received transaction number and the received identification number with stored values and accepts the vote contained in the response, if the check is positive. The object of the present invention is further achieved by a mobile terminal for supporting a voting, the mobile terminal comprises a communication unit for communicating with a vote server through a communication network and a control unit, wherein the control unit is adapted to receive an unique transaction number together with a voting item from a vote server, wherein the transaction number is associated with a specific voting item and a specific subscriber, and to send a response comprising the vote together with the transaction number and a unique identification number associated with the subscriber of the mobile terminal to the vote server. The object of the present invention is further achieved by a computer program product for supporting a voting, wherein the computer program product performs, when executed by a mobile terminal, the steps of: receiving a unique transaction number together with a specific voting item from a vote server, the unique transaction number is associated with a specific voting item and the specific subscriber of the mobile terminal; and sending a response comprising the vote together with a transaction number and a unique identification number associated with the subscriber of the mobile terminal to the vote server.

The present invention improves the security, user friendliness and technical implementation of a mobile terminal base voting procedure. Fraud is avoided. For example, double voting or vote by not authorized persons is prevented. Further, the invention can easily be implemented in existing systems and existing mechanisms of mobile terminals are reused. Further, existing terminals may easily be adapted to support a method according to this invention.

According to a preferred embodiment of the invention, the vote server downloads vote program code to the mobile terminal. This vote program code, for example a JAVA Midlet, handles the reception and retransmission of the transaction number in the following. Further, this vote program code may handle the whole communication with a vote server and can already contain additional vote information, for example a list of and detailed information about several voting items. This approach improves the user interface presented to the subscriber and improves the quality and security of the service provisioning.

Instead of downloading such vote program code, it is also possible to pre-install such a vote program code within the mobile terminal. But, the download of the vote program code provides a higher flexibility.

To prevent the vote of unauthorized persons in case of subscriber change, the vote program code is automatically deleted, when the SIM card (SIM=Subscriber Identification Module) of the mobile terminal is changed. In case of a subscriber change without a change of the SIM card he Id in the mobile terminal, following procedure may be executed to provide the above described benefit: A message is sent to the vote server: The vote server correlates the IMSI (International Mobile Subscriber Identity) with the user-database of the vote server and downloads the vote program code in case of a positive correlation result.

Further, the security and safety of the voting method can be improved by using a security protocol layer, for example SSL (Secured Socket Layer) within the communication between the mobile terminal and the vote server.

Following procedures can be introduced to improve the efficiency of the vote process: On request, a set of current voting items, the subscriber is entitled to, is downloaded from the vote server to the mobile terminal. It is possible for the user to access this list, display items of this list and initiate a voting process for selected voting items of this list. Further, the vote server can send a vote invitation to the mobile terminal and transmit the unique transaction number when receiving a corresponding vote request from the mobile terminal. Further, it can send an acknowledgment after receipt of the vote.

### BRIEF DESCRIPTION OF THE DRAWINGS

These as well as other features and advantages of the invention will be better appreciated by reading the following detailed description of presently preferred exemplary embodiments taken into conjunction with accompanying drawings of which:

FIG. 1 is a block diagram which shows a voting system with a vote server and several mobile terminals according to the invention.

FIG. 2 is a detail functional view of the vote server and one of the mobile terminals of FIG. 1.

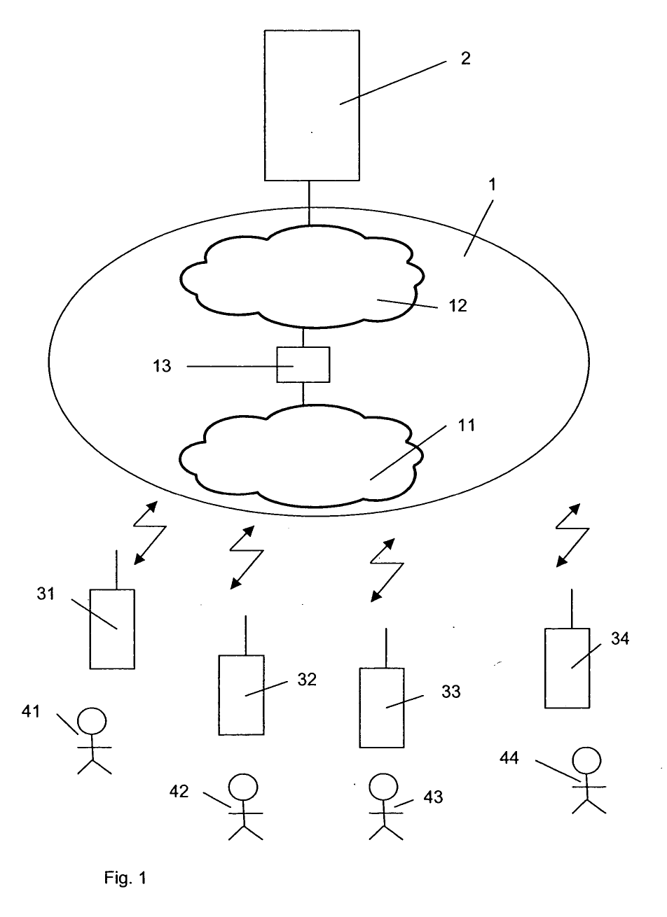

FIG. 1 shows a voting system with a vote server 2, a communication network 1, several mobile terminals 31 to 34 and several subscribers 41 to 44.

The communication network 1 provides a wireless access between the mobile terminals 31 to 34 and the vote server 2. For example, the communication network 1 is constituted of a cellular mobile network 11, for example according to a GSM-standard or a UMTS-standard (GSM=Global System for Mobile Communication; UMTS=Universal Mobile Telecommunications), and an IP-network 12 (IP=Internet Protocol). Such an IP-network can be constituted of various different physical networks interconnected via the use of an IP-protocol as layer 3 protocol. Such different physical networks are for example Ethernet, ATM or MPLS networks, using such aforementioned protocols as medium access protocols. (ATM=Asynchronous Transfer Mode; MPLS=Multi Protocol Label Switch). According to this embodiment, the vote server 2 is an internet server, connected through a cellular radio network and via a gateway 13 between the cellular radio network and the IP-network with the mobile terminals 31 to 34. But, it is also possible that the vote server 2 is a server associated with a cellular radio network and, for example, is dedicated to provide a voting service for subscribers of this cellular radio network. In this case, the communication network 1 may be solely constituted by the cellular radio network of a specific network operator. For example, the vote server 2 may provide a vote service based on the IN infrastructure (IN=Intelligent Network) or another telecommunication based service provisioning architecture.

The mobile terminals 31 to 34 are cellular phones communicating with the communication network 1 via an air interface. For example, these cellular phones communicate according to the GSM, UMTS or CDMA 2000 standard. Further, it is possible that the mobile terminals 31 to 34 are constituted by computers containing a transceiver which enables the communication via the communication network 1.

The subscribers 41, 43 and 44 are associated with the mobile terminals 31, 32 and 34, respectively.

Following steps have to be performed for voting:

First, the users which are entitled in voting have to be specified. This specification may be done by an access to the vote server 2, which refers to a number of users and/or user groups of users, already registered in the vote server 2. The specification of the voting may be defined by help of a web-interface provided by the vote server 2. But, it is also possible that the specification is done by help of accessing the vote server 2 through one of the mobile terminals 31 to 34.

In the next step, the vote server 2 sends vote invitations to mobile terminals assigned to the users entitled to vote. When receiving a corresponding vote request from one of these mobile terminals, the vote server 2 generates a unique transaction number associated with the specific voting item and the specific subscriber of this mobile terminal. Then, it transmits this unique transaction number together with the specific voting item to this mobile terminal.

The mobile terminal indicates to its subscriber that he is now in a position to vote. Further, the mobile terminal requests to enter the unique identification number of the subscriber. When the subscriber has entered his vote and his identification number, the mobile terminal sends a response message back to the vote server, the response message comprises the vote, the transaction number and the identification number entered by the subscriber.

The vote server 2 compares the received data with stored values. It compares the received transaction numbers with the transaction number it has generated for this voting item and in addition checks whether this transaction number was already used for vote. Further, it checks whether the identification number associated with the transaction number in the response is assigned to the user the transaction number is generated for. If both checks are positive, the vote server 2 accepts the vote contained in the response. The accepted votes are stored and collected in an anonymous form and are used to determine the result of the voting.

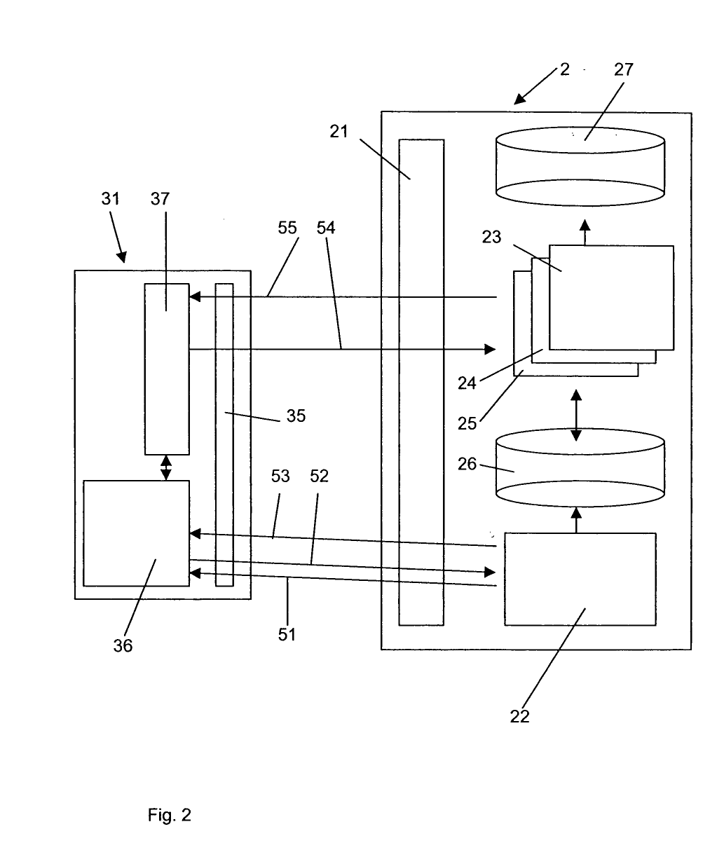

In the following, details of this voting process are described by help of FIG. 2.

FIG. 2 shows the vote server 2 and the mobile terminal 31. The vote server 2 is constituted of one or several interlinked computers and the software executed by these computers. Based on a system platform formed by such a hardware platform and software platform, several application programs are executed by the vote server 2. These application programs control the funcitonality of the vote server 2. The functionality is provided by the above-described interactions of the software and hardware of the vote server 2. From the functional point of view, the vote server 2 comprises a communication unit 21, two memory units 27 and 26, and several control units 22, 23, 24 and 25.

The mobile terminal 31 is constituted by a microprocessor, associated peripheral components and input and output means as well as program code executed by this microprocessor. The functions of the mobile terminal 31 are performed by the execution of this program code based on these hardware platform. From the functional point of view, the mobile terminal 31 comprises a communication unit 35 and two control units 36 and 37.

The communication units 21 and 35 enable the communication between the mobile terminal 31 and the vote server 2 via the communication network 1. For example, the communication unit 35 comprises all functionalities for communicating via a GSM or UMTS cellular communication network and the higher transport services used for the communication between the vote server 2 and the mobile terminal 31. These communication services may be GPRS, SMS or secured protocol layers like a SSL layer (SSL=Secured Socket Layer). The lower protocol layers provided by the communication unit 2 depend on the way how the vote server 2 is connected to the cellular network serving the mobile terminal 31. For example, These protocol layers may be the TCP/IP protocol stack (TCP=Transmission Control Protocol, IP=Internet Protocol). Further, the communication unit 21 may provide higher transport protocols, as already described in conjunction with the communication unit 35.

The control unit 22 is responsible for vote and user administration. It administrates the registered users of the vote system, handles the registering of new users and the erasure of users out of the user data bank of the vote server 2. Further, it administrates the creation and amendment of user groups, for example assigned to specific organizations or vote groups.

According to one embodiment of the invention, the control unit 22 downloads vote program code to the mobile terminal of each registered user. This download may be executed as soon as the user is registered or as soon as the user requests or acknowledges the download of such vote program code from the vote server 2. Such vote program code can be encoded as JAVA Midled. Preferably, this vote program code is a basic vote program code, which is independent form specific voting item. It may be supplemented by further, voting items specific vote program code, if such supplementary specific voting item program code is available for specific voting items.

According to another embodiment of the invention, the control unit 22 downloads a voting item specific vote program code, as soon as a subscriber agrees to participate in a voting by means of his mobile terminal.

For example, the control unit 22 receives a request to initiate a voting for a specific voting item. This request concerns information about the voting item as well as a list of the invited users. This list may refer to user groups or a selection of single registered users. For each of the invited users, the control unit 22 performs the following procedure:

It accesses the user administration data base and determines the communication address of the mobile terminal assigned to the specific user. For example, the subscriber 41 represents an invited user and the control unit 22 selects the communication address of the mobile terminal 31, for example the phone number of the mobile terminal 31. Then, it directs a vote invitation 51 to the mobile terminal addressed by this communication address. This vote invitation may contain the voting item as well as some further information about this voting. If the subscriber 41 decides to participate in this voting by means of his mobile terminal 31, it sends back an acknowledgement message 52 to the vote server 2. The messages 51 and 52 can be HTTP-messages or even also SMS-messages (SMS=Short Message Service, HTTP=Hypertext Transfer Protocol).

If the control unit receives an acknowledgment message from a mobile terminal, it downloads vote program code, for example a vote program code 53, to this mobile terminal. Further, it registers this user as vote participant in the memory unit 26.

The mobile terminals which receive such vote program code, for example the mobile terminal 31, install this vote program code and initiate the execution of this vote program code. For example, the control unit 36 controls the vote server independent functionalities of the mobile terminal 31. If the mobile terminal 31 is a cellular phone, the control unit 36 represents all control functionalities which are typically integrated in such mobile phone. The downloaded vote program code 53 is stored in a memory of the mobile terminal 31 and in the following executed based on the software platform provided by the control unit 36. In the following, the whole voting specific communication between the mobile terminal 31 and the vote server 2 is handled by this executed vote program code, which forms the control unit 37.

When the control unit 22 has built a voters list within the memory unit 26 by means of the above-described process, a vote process is created within the vote server 2. The control units 23 to 25 represent three of such vote process, each of which is responsible for a different voting item. For example, the control unit 25 represents the vote process, responsible for the voting item which is associated with the vote program code 53.

The control unit 25 generates for each of the users indicated in the voters list a unique transaction number. Each of these transaction numbers is associated with a specific voting item and a specific subscriber, which means that there exists a unique transaction number for each combination of voting item and subscriber.

The control unit 25 transmits the generated transaction numbers together with the voting item to the mobile terminals associated with the users of the voters list. For example, it sends a message 55 containing the unique transaction number associated with the subscriber 41 and the voting item to the mobile terminal 31. This message is handled by the control unit 37, which interprets this message and initiates a corresponding interaction with the subscriber 41. For example, the control unit 37 initiates to display a message to the subscriber 41 explaining the voting item and requesting the users to enter his vote. Further, the control unit 37 requests the user to enter his user identification number.

Such user identification number is agreed between the user and the vote server 2 within the user registration process. This user identification number is, for example, a four or a six digit word.

Further, it is also possible that the user pre-stores its user identification number within the mobile terminal or on his SIM card. Further, it is possible that user specific data already stored on the SIM card of the user are used as user identification number (e.g. IMSI=International Mobile Subscriber Identity). Such data is directly accessed by the control unit 37 so it is not longer necessary for the user to enter and remember to his user identification number.

Then, the control unit 37 sends back a response 54 to the control unit 25. The response 54 comprises the vote of the user, the transaction number received by the control unit 37 and the unique user identification number of the subscriber 41. The control unit 25 compares the received transaction number with the transaction numbers generated for this voting item. If it fits with such a generated transaction number, it compares the user identification number with the user identification number assigned to the user, to whom the transaction number is associated with within the user administration data base of the vote server 2. If the user identification number is correct, the control unit 25 accepts the vote. Each accepted vote is stored in an anonymous form within the memory unit 27. For example, the memory unit 27 comprises counters for each vote possibility. The counter assigned to the vote possibility which fits with the vote is increased when the vote is accepted. Further, the control unit 25 deletes each transaction number assigned to an accepted vote out of the list of generated transaction numbers to ensure that each transaction number may only be used for one vote. By this, double voting is prevented.

Further, it is possible that the control unit 25 sends a vote acknowledgment to the control unit 37, if the vote is accepted. The transmission of such acknowledgment may also depend on the user profile assigned to the subscriber 41 or on a flag set in the response 54.

Further, it is possible that mechanisms of the cellular network are used to increase the security and safety of the vote process. For example, user specific data and information stored on the SIM card of the mobile terminal 31 may be accessed by the control unit 37 and transmitted within the response 54 to the control unit 25. The control unit 25 compares this additional data with the corresponding data stored in the user administration of the cellular network. Further, it is also possible that user specific data of the SIM card are used to encrypt a random number submitted by the control unit 25 to the control unit 37. The encrypted data are resent to the control unit 25, decrypted by the control unit 25 and compared with the originally sent random number to perform a further authentication of the voter.

Further, additional mechanisms can be provided to increase security of the system in case of a SIM card change. For example, the control unit 36 or the control unit 37 automatically delete the vote program code out of the memory of the mobile terminal 31, if it detects that the SIM card of the mobile terminal 31 is replaced by another one.

Further features may be introduced in the vote process when implementing the above-described concept of a basic vote program code which handles not only a single voting item, but all functionalities of the voting service. For example, such vote program code can provide functionalities as the download of a list of all available voting items, vote results and so on. As already mentioned above, such basic vote program code may be supported by supplementary, voting item specific program code. But, it is also possible that no additional program code, but voting item specific information is sent to the mobile terminal in case of a vote invitation.

Such basic, supplementary or voting item specific vote program code which is downloaded from the vote server to the mobile terminal or installed on the mobile terminal by another way forms a computer program product which supports the voting. Such computer program product may be program code as such, but also program code stored on a storage medium, for example a memory of the vote server 2 or the mobile terminals 31 to 34.

1. A method for performing a voting, wherein a mobile terminal receives a voting item from a vote server and sends back a response comprising the vote of the subscriber of said mobile terminal, wherein
the method comprises the steps of:
generating a unique transaction number associated with a specific voting item and a specific subscriber;
transmitting the unique transaction number together with the specific voting item from the vote server to the mobile terminal of the specific subscriber;
sending a response comprising the vote together with the transaction number and a unique identification number associated with the subscriber of the mobile terminal to the vote server; and
comparing, by the vote server, the received transaction number and the received identification number with stored values and accept the vote contained in the response, if the check is positive.

2. The method of claim 1, wherein
the method comprises the further step of downloading vote program code from the vote server to the mobile terminal, the vote program code handles the reception and retransmission of the transaction number.

3. The method of claim 2, wherein
the method comprises the further step of deleting the vote program code, when the SIM card of the mobile terminal is changed.

4. The method of claim 1, wherein
the method comprises the further step of accessing information stored on the SIM card of the mobile terminal and performing a subscriber authentication based on said information and subscriber data stored in the vote server.

5. The method of claim 1, wherein
the method comprises the further step of using a secured protocol layer for the communication between the mobile terminal and the vote server.

6. The method of claim 1, wherein
the method comprises the further steps of downloading a set of current voting items, the subscriber is entitled to, from the vote server to the mobile terminal and displaying this set of current voting items to the subscriber.

7. The method of claim 1, wherein
the method comprises the further steps of sending a vote invitation to the mobile terminal and transmitting the unique transaction number when receiving a corresponding vote request from the mobile terminal.

8. A vote server for supporting a voting, the vote server comprises a communication unit for communicating with mobile terminals through a communication network, wherein
the vote server comprises a control unit for generating unique transaction numbers, each transaction number is associated with a specific voting item and a specific subscriber, for transmitting a corresponding unique transaction number together with a voting item to a mobile terminal of a subscriber, who is invited to a vote, for receiving a corresponding response form the mobile terminal, wherein the response comprises the vote together with the transaction number and a unique identification number associated with subscriber of the mobile terminal, and for comparing the received transaction number and the received identification number with stored values and accept the vote contained in the response, if the check is positive.

9. A mobile terminal for supporting a voting, wherein the mobile terminal comprises a communication unit for communicating with a vote server through a communication network, wherein
the mobile terminal comprises a control unit for receiving a unique transaction number together with a voting item from the vote server, the unique transaction number is associated with a specific voting item and a specific subscriber, and for sending a response comprising the vote together with the transaction number and a unique identification number associated with the subscriber of the mobile terminal to the vote server.

10. Computer program product for supporting a voting, wherein
the computer program product performs, when executed by a mobile terminal the steps of: receiving a unique transaction number together with a specific voting item from a vote server, wherein the unique transaction number is associated with the specific voting item and the specific subscriber of the mobile terminal; and sending a response comprising the vote together with the transaction number and a unique identification number associated with the subscriber of the mobile terminal to the vote server.
